(19) United States
(12) Patent Application Publication
(10) Pub. No.: US 2013/0062936 A1
(43) Pub. Date: Mar. 14, 2013

(54) LOAD CONTROL DEVICE

(71) Applicant: Takashi Aragai, Aichi (JP)

(72) Inventor: Takashi Aragai, Aichi (JP)

(73) Assignee: OMRON AUTOMOTIVE ELECTRONICS CO., LTD., Aichi (JP)

(21) Appl. No.: 13/615,105

(22) Filed: Sep. 13, 2012

(30) Foreign Application Priority Data
Sep. 13, 2011 (JP) 2011-199266

(51) Int. Cl. B60L 1/00

(52) U.S. Cl. 307/9.1

(57) ABSTRACT

A load control device controls a load of a vehicle based on a signal inputted from a manipulation part manipulated by a user. The load control device includes a first command part that issues a first command to supply electric power to the load based on the signal from the manipulation part, a monitor that monitors existence or non-existence of an abnormality of the first command part, and outputs a reset signal in order to reset a state of the first command part when the abnormality of the first command part is detected, a second command part that issues a second command to supply the electric power to the load when the reset signal is inputted from the monitor, and an electric-power supply controller that controls the supply of the electric power to the load based on the first command or the second command.

### 1. TECHNICAL FIELD

The present invention relates to a load control device and particularly to a load control device that controls a load of a vehicle.

### 2. RELATED ART

Conventionally, there is proposed a technology of being able to light a headlight even if a communication failure is generated between a manipulation switch of the headlight and a control device that controls the headlight.

For example, in a proposal of Japanese Unexamined Patent Publication No. 7-232603, a transmission-side ECU (Electronic Control Unit) including a headlight switch and a headlight ECU are connected to each other by a communication bus and a power source supply line. When the headlight switch is turned on, communication data of an on state of the headlight is supplied from the transmission-side ECU to the headlight ECU through the communication bus, and an analog signal of the on state of the headlight is supplied from the transmission-side ECU to the headlight ECU through the power source supply line. Therefore, even if the communication bus is disconnected, the headlight can be lit using the analog signal passed through the power source supply line.

Conventionally, there is also proposed an in-vehicle system in FIG. 1.

Specifically, the in-vehicle system in FIG. 1 includes a combination SW (switch) 11, a BCM (Body Control Module) 12, and a headlight 13. The combination SW 11 includes a headlight SW 21 and a CPU 22. The BCM 12 includes a CPU 31, a high-side driver 32, and a transistor TR. The combination SW 11 and the BCM 12 are connected to each other through a communication line 14 and a signal line 15.

When the headlight SW 21 of the combination SW 11 is turned on, the CPU 22 detects the turn-on of the headlight SW 21, and starts the output of a headlight turn-on signal to the CPU 31 of the BCM 12 through the communication line 14. The CPU 31 that receives the headlight turn-on signal outputs a command signal of a positive logic (high active) to the high-side driver 32 in order to cause the high-side driver 32 to light the headlight 13. In response to the input of the command signal, the high-side driver 32 starts the supply of electric power from a battery power source +B to the headlight 13 to light the headlight 13.

When the headlight SW 21 is turned on, a potential at a base of the transistor TR becomes a low level (ground level) to turn on the transistor TR. While the ignition power source is turned on, the electric power is inputted from the ignition power source IG to the high-side driver 32 through the transistor TR. Therefore, the input voltage of the high-side driver 32 becomes a high level, and the high-side driver 32 becomes the state similar to the state in which the command signal is inputted.

Accordingly, as illustrated in FIG. 2, the headlight 13 can be lit by turning on the ignition power source IG and the headlight SW 21, even if the CPU 31 cannot detect the state of the headlight SW 21 because a failure is generated in the communication line 14 to generate the communication failure between the CPU 22 and the CPU 31.

However, in the proposal of Japanese Unexamined Patent Publication No. 7-232603 and the in-vehicle system in FIG. 1, the number of wiring systems between the transmission-side ECU and the headlight ECU increases by one, and the number of wiring systems between the combination SW 11 and the BCM 12 increases by one. Therefore, it is necessary to add a harness and a connector pin for the increased wiring system, which results in a cost increase and a weight gain of the vehicle.

In the proposal of Japanese Unexamined Patent Publication No. 7-232603 and the in-vehicle system in FIG. 1, the headlight cannot be lit when abnormalities, such as a disconnection, a power-source short circuit, and a ground fault, are simultaneously generated in the two wiring systems.

In the proposal of Japanese Unexamined Patent Publication No. 7-232603, the headlight cannot be lit when the abnormality is generated in the headlight ECU though the abnormality is not generated in the wiring system.

### SUMMARY

One or more embodiments of the present invention can surely actuate a vehicle load, such as the headlight.

In accordance with a first aspect of the present invention, there is provided a load control device that controls a load of a vehicle based on a signal inputted from a manipulation part manipulated by a user, the load control device including: a first command part that issues a first command to supply electric power to the load based on the signal from the manipulation part; a monitor that monitors existence or non-existence of an abnormality of the first command part, and outputs a reset signal in order to reset a state of the first command part when the abnormality of the first command part is detected; a second command part that issues a second command to supply the electric power to the load when the reset signal is inputted from the monitor; and an electric-power supply controller that controls the supply of the electric power to the load based on the first command or the second command.

In the load control device in accordance with the first aspect of the present invention, the first command part issues the first command to supply the electric power to the load based on the signal from the manipulation part, the monitor monitors the existence or non-existence of the abnormality of the first command part, and outputs the reset signal in order to reset the state of the first command part when the abnormality of the first command part is detected, the second command part issues the second command to supply the electric power to the load when the reset signal is inputted from the monitor, and the supply of the electric power to the load is controlled based on the first command or the second command.

Accordingly, the vehicle load can surely be actuated.

For example, the manipulation part includes manipulation means, such as a switch, a button, and a key. For example, the first command part includes a control circuit, such as a CPU (Central Processing Unit) and an ECU (Electronic Control Unit). For example, the monitor includes a watchdog timer. For example, the second command part includes a drive retaining and integrating circuit or a drive retaining circuit. For example, the electric-power supply controller includes a driver circuit.

The second command part may issue the second command when a predetermined power source of the vehicle is turned on.

Therefore, for example, when the abnormality is generated in the first command part, the on and off states of the load can be controlled by turning on and off the predetermined power source of the vehicle.

The second command part may issue the second command by outputting the electric power from the predetermined power source of the vehicle to the electric-power supply controller.

Therefore, the configuration of the second command part can be simplified.

The first command part may issue the first command based on an on state of the power source of a drive system of the vehicle when communication failure is detected between the first command part and the manipulation part.

Therefore, the vehicle load can surely be actuated even if the communication failure is generated between the manipulation part and the first command part.

The predetermined power source of the vehicle may be a power source of a drive system of the vehicle.

Therefore, for example, the load can be started up and stopped in conjunction with the power source of the drive system of the vehicle during the generation of the abnormality.

The reset signal may be a pulsing signal, and the second command part may issue the second command when a predetermined number of pulses of the reset signal are inputted.

Therefore, the malfunction caused by the noise can be prevented.

The second command part may include an integrating circuit including a capacitor, and the second command part may issue the second command when a charge amount accumulated in the capacitor by the input of the reset signal is greater than or equal to a predetermined threshold.

Therefore, the second command can be issued by easily inputting the predetermined number of reset signal pulses.

The first command part may output a stop signal in order to stop the second command when operating normally, and the load control device may further include a stop part that stops the second command issued by the second command part when the stop signal is inputted from the first command part.

Therefore, the second command can surely be stopped.

For example, the stop part includes an electric circuit that includes switching elements, such as a transistor.

The first command part may detect whether the second command part issues the second command, and the first command part may output the stop signal when the second command part issues the second command while the first command part operates normally.

Therefore, the processing of stopping the second command can be performed only when the second command is issued.

The stop signal may be a pulsing signal, and the stop part may stop the second command issued by the second command part when a predetermined number of pulses of the stop signal are inputted.

Therefore, the malfunction caused by the noise can be prevented.

The stop part may include an integrating circuit including a capacitor, and the stop part may stop the second command issued by the second command part when a charge amount accumulated in the capacitor by the input of the stop signal is greater than or equal to a predetermined threshold.

Therefore, the second command can be stopped by easily inputting the predetermined number of stop signal pulses.

In accordance with a second aspect of the present invention, there is provided a load control device that controls a load of a vehicle based on a signal inputted from a manipulation part manipulated by a user, the load control device including: a first command part that issues a first command to supply electric power to the load based on the signal from the manipulation part; a monitor that monitors existence or non-existence of an abnormality of the first command part, and outputs a fault detection signal when the abnormality of the first command part is detected; a second command part that issues a second command to supply the electric power to the load when the fault detection signal is inputted from the monitor; and an electric-power supply controller that controls the supply of the electric power to the load based on the first command or the second command.

In the load control device in accordance with the second aspect of the present invention, the first command part issues the first command to supply the electric power to the load based on the signal from the manipulation part, the monitor monitors the existence or non-existence of the abnormality of the first command part, and outputs the fault detection signal when the abnormality of the first command part is detected, the second command part issues the second command to supply the electric power to the load when the fault detection signal is inputted from the monitor, and the supply of the electric power to the load is controlled based on the first command or the second command.

Accordingly, the vehicle load can surely be actuated.

For example, the manipulation part includes manipulation means, such as a switch, a button, and a key. For example, the first command part includes a control circuit, such as a CPU (Central Processing Unit) and an ECU (Electronic Control Unit). For example, the monitor includes a watchdog timer. For example, the second command part includes a drive retaining and integrating circuit or a drive retaining circuit. For example, the electric-power supply controller includes a driver circuit.

According to one or more embodiments of the present invention, the vehicle load can surely be actuated.

### BRIEF DESCRIPTION OF THE DRAWINGS

FIG. 1 is a circuit diagram illustrating a configuration example of a conventional in-vehicle system;

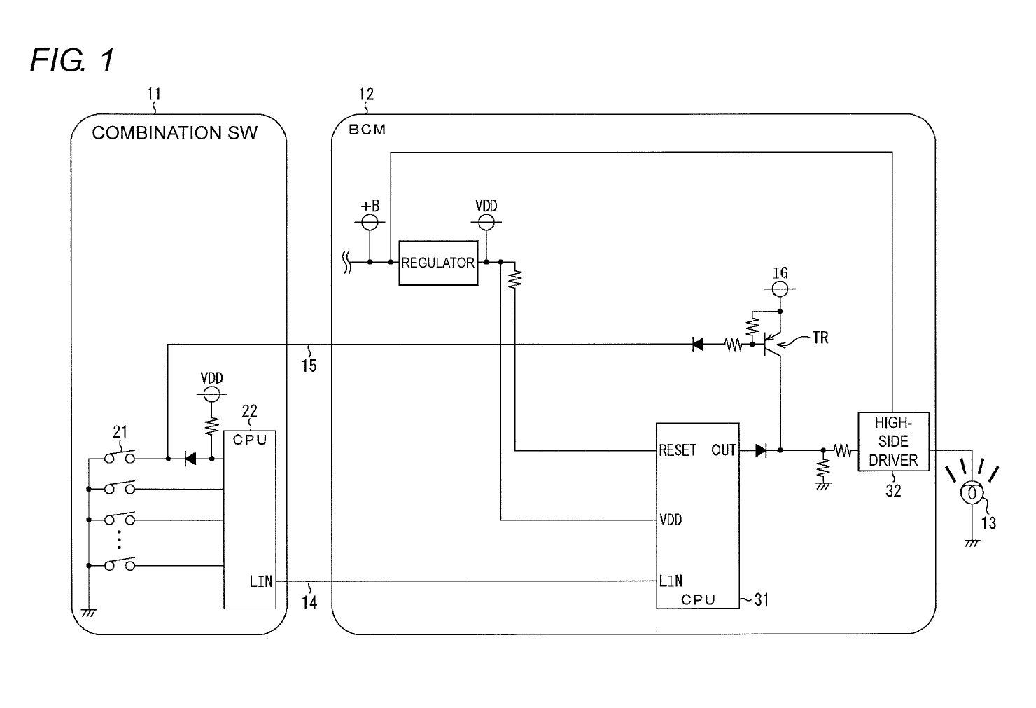

FIG. 2 is a diagram illustrating an operation of the conventional in-vehicle system in generating a communication failure;

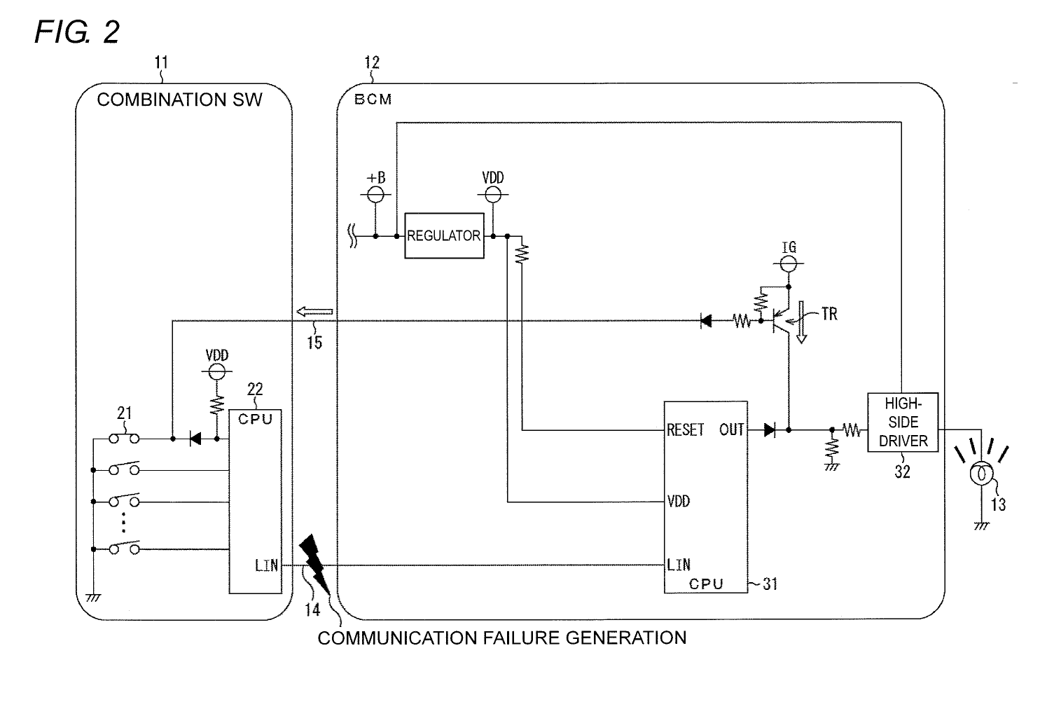

FIG. 3 is a block diagram illustrating a basic configuration example of an in-vehicle system according to a first embodiment of the present invention;

FIG. 4 is a circuit diagram illustrating a specific configuration example of the in-vehicle system of the first embodiment of the present invention;

FIG. 5 is a diagram illustrating a normal operation of the in-vehicle system of the first embodiment of the present invention;

FIG. 6 is a diagram illustrating an operation of the in-vehicle system of the first embodiment of the present invention in generating the communication failure;

FIG. 7 is a diagram illustrating an operation of the in-vehicle system of the first embodiment of the present invention in generating an abnormality of the CPU;

FIG. 8 is a graph illustrating a change in voltage of each part of a BCM;

FIG. 9 is a block diagram illustrating a basic configuration example of an in-vehicle system according to a second embodiment of the present invention;

FIG. 10 is a circuit diagram illustrating a specific configuration example of the in-vehicle system of the second embodiment of the present invention;

FIG. 11 is a diagram illustrating the normal operation of the in-vehicle system of the second embodiment of the present invention;

FIG. 12 is a diagram illustrating the operation of the in-vehicle system of the second embodiment of the present invention in generating the communication failure;

FIG. 13 is a diagram illustrating the operation of the in-vehicle system of the second embodiment of the present invention in generating an abnormality of the CPU;

FIG. 14 is a circuit diagram illustrating a specific configuration example of an in-vehicle system according to a third embodiment of the present invention; and

FIG. 15 is a diagram illustrating the operation of the in-vehicle system of the third embodiment of the present invention.

### DETAILED DESCRIPTION

Hereinafter, embodiments of the present invention will be described. The description is made in the following order.

1. First Embodiment (the case that drive retaining and integrating circuit is used)

2. Second Embodiment (the case that drive retaining circuit and shut-down circuit are used)

3. Modifications

### 1. First Embodiment

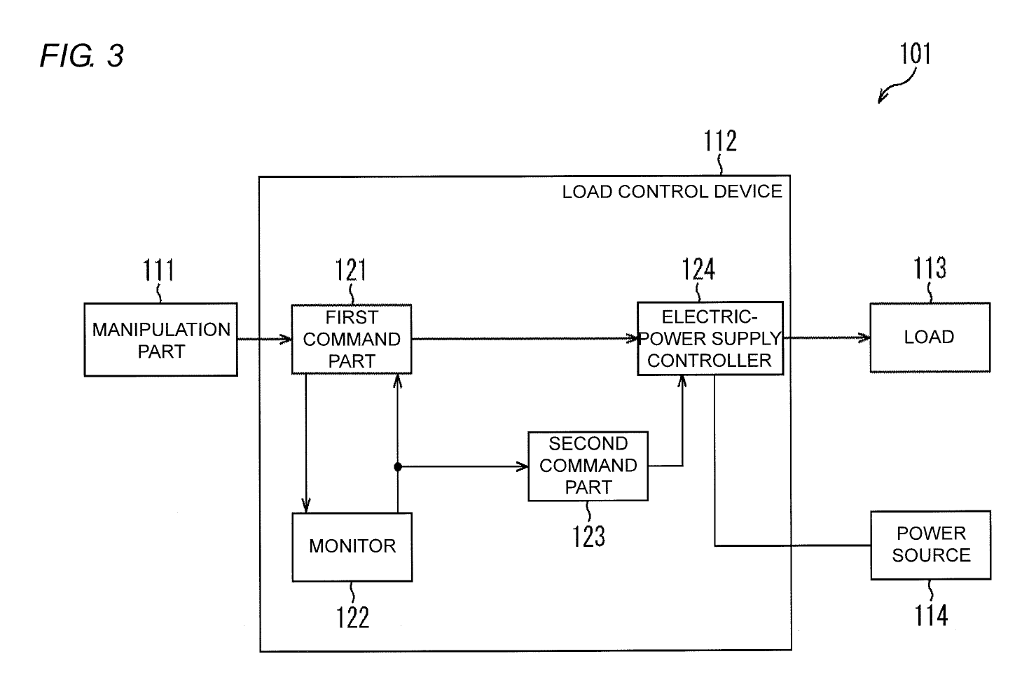

A first embodiment of the present invention will be described with reference to FIGS. 3 to 8.

[Basic Configuration Example of In-Vehicle System of First Embodiment]

FIG. 3 is a block diagram illustrating a basic configuration example of an in-vehicle system according to the first embodiment of the present invention.

Referring to FIG. 3, an in-vehicle system 101 includes a manipulation part 111, a load control device 112, a load 113, and a power source 114. The load control device 112 includes a first command part 121, a monitor 122, a second command part 123, and an electric-power supply controller 124.

The in-vehicle system 101 is a system, which is provided in various vehicles and controls of supply of electric power to the load 113 according to a user manipulation of the manipulation part 111. There is no particular limitation to a kind of a vehicle in which the in-vehicle system 101 is provided. For example, it is conceivable that the in-vehicle system 101 is provided in a vehicle that is driven by an engine, an EV (Electric Vehicle), an HEV (Hybrid Electric Vehicle), and a PHEV (Plug-in Hybrid Electric Vehicle).

The manipulation part 111 includes various manipulation means (such as a switch, a button, and a key). For example, a user manipulates the manipulation part 111 to start up or stop the load 113. The manipulation part 111 outputs a manipulation signal indicating a manipulation content or a state of the manipulation part 111 (for example, an on/off state) to the first command part 121.

For example, the first command part 121 includes various control circuits, such as a CPU (Central Processing Unit) and an ECU (Electronic Control Unit). Based on a manipulation signal from the manipulation part 111, the first command part 121 issues a command to the electric-power supply controller 124 to supply the electric power to the load 113. When detecting a failure of communication with the manipulation part 111, the first command part 121 issues the command to the electric-power supply controller 124 to supply the electric power to the load 113 based on a power source state of the vehicle. The first command part 121 periodically outputs a predetermined signal to the monitor 122 when operating normally. When a reset signal is inputted from the monitor 122, the first command part 121 resets its state to an initial state by performing restart.

For example, the monitor 122 includes a watchdog timer. The monitor 122 monitors the existence or non-existence of an abnormality of the first command part 121 based on the signal inputted from the first command part 121. When detecting the abnormality of the first command part 121, the monitor 122 outputs the reset signal to the first command part 121 and the second command part 123 in order to reset the state of the first command part 121. It is also said that the reset signal is a fault detection signal, which is outputted when the monitor 122 detects the abnormality of the first command part 121.

For example, the second command part 123 includes electric circuits, such as a drive retaining and integrating circuit. When the reset signal is inputted from the monitor 122, the second command part 123 issues the command to the electric-power supply controller 124 to supply the electric power to the load 113 based on the power source state of the vehicle.

For example, the electric-power supply controller 124 includes a driver circuit that controls the supply of the electric power to the load 113. Based on the command from the first command part 121 or the second command part 123, the electric-power supply controller 124 controls the supply of the electric power from the power source 114 to the load 113, thereby controlling start-up and stop of the load 113.

For example, the load 113 includes various in-vehicle electric components that can be started up and stopped by manipulating the manipulation part 111. For example, the load 113 includes electric components, such as a headlight, a taillight, and a windshield wiper motor, which are necessary to drive the vehicle safely.

For example, the power source 114 includes a battery provided in the vehicle.

[Specific Configuration Example of In-Vehicle System of First Embodiment]

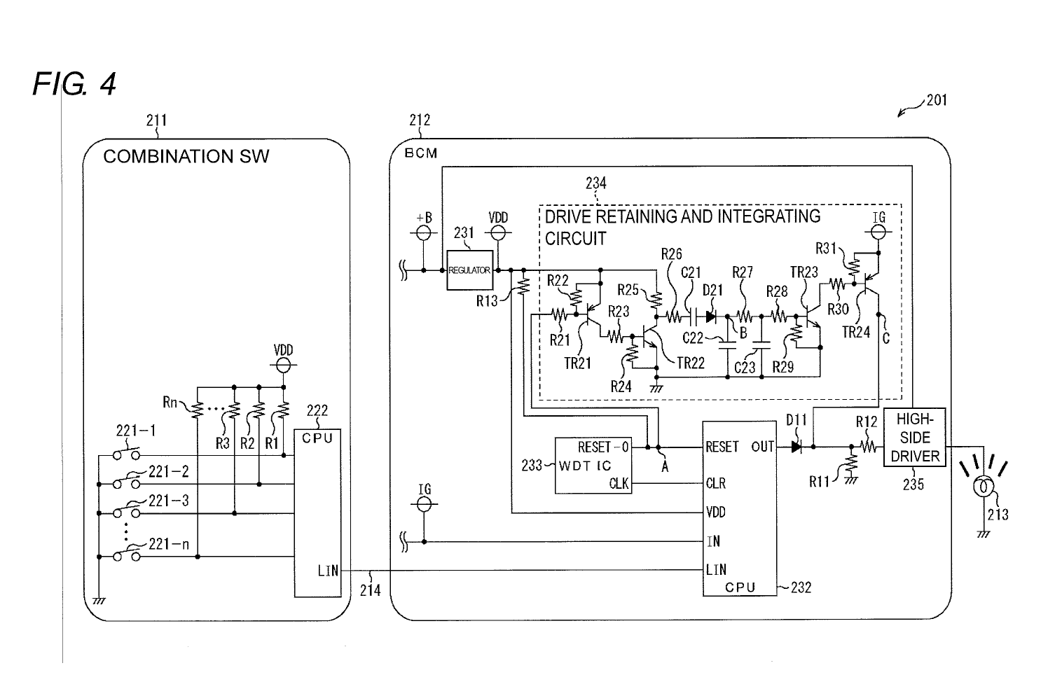

FIG. 4 is a circuit diagram illustrating a configuration example of an in-vehicle system 201 in which the in-vehicle system 101 in FIG. 3 is objectified.

The in-vehicle system 201 includes a combination SW (switch) 211, a BCM (Body Control Module) 212, and a headlight 213.

The combination SW 211 corresponds to the manipulation part 111 in FIG. 3. The combination SW 211 includes switches 221-1 to 221-n, a CPU 222, and resistors R1 to Rn.

The switches 221-1 to 221-n switch operations and states of various loads of the vehicle in which the in-vehicle system 101 is provided. The switch 221-1 switches between the on and off states of the headlight 213. Hereinafter, the switch 221-1 is referred to as a headlight SW (switch).

One end of each of the switches 221-1 to 221-n is connected to the CPU 222, and the other end is connected to a ground. A power source VDD that supplies the electric power of a predetermined DC voltage (for example, 5 V) is connected to the CPU 222 while the resistors R1 to Rn are interposed between the switches 221-1 to 221-n and the CPU 222, respectively.

A line terminal (LIN) of the CPU 222 is connected to a line terminal (LIN) of a CPU 232 of the BCM 212 through a communication line 214, and the CPU 222 and the CPU 232 communicate with each other through the communication line 214. For example, the CPU 222 detects the states of the switches 221-1 to 221-n, and outputs a signal (hereinafter, referred to as a switch state signal) notifying the CPU 232 of the detected state to the CPU 232 through the communication line 214.

The BCM 212 includes a regulator 231, the CPU 232, a WDT (watchdog timer) IC 233, a drive retaining and integrating circuit 234, a high-side driver 235, a diode D11, and resistors R11 to R13. The CPU 232 corresponds to the first command part 121 in FIG. 3, the WDT IC 233 corresponds to the monitor 122 in FIG. 3, the drive retaining and integrating circuit 234 corresponds to the second command part 123 in FIG. 3, and the high-side driver 235 corresponds to the electric-power supply controller 124 in FIG. 3.

An input terminal of the regulator 231 is connected to a battery power source +B that supplies an electric power of a predetermined DC voltage (for example, 12 V) from the battery (not illustrated). An output terminal of the regulator 231 is connected to the power source VDD and a power source terminal (VDD) of the CPU 232. The regulator 231 converts a voltage of the electric power supplied from the battery power source +B into a predetermined voltage (for example, +5 V) and supplies the voltage to the CPU 232.

An input terminal (IN) of the CPU 232 is connected to an ignition power source IG that supplies the electric power of the predetermined voltage (for example, +12 V).

The ignition power source IG is a power source of a drive system of the vehicle, and the ignition power source IG supplies the electric power when an ignition switch or a power switch of the vehicle is set to a position in which the vehicle is put into a movable state or a position (for example, an ignition or the on state) in which the user drives the vehicle. The CPU 232 detects the on and off states of the ignition power source IG based on the input voltage at the input terminal. The CPU 232 can detect whether the ignition switch or the power switch is to set to the ignition or the on state based on a detection result of the on and off states of the ignition power source IG.

Hereinafter, a name of the switch that switches the on and off states of the ignition power source IG is unified by an ignition switch, and a name of the position of the ignition switch in which ignition power source IG is turned on is unified by ignition.

A clear terminal (CLR) of the CPU 232 is connected to the a clock terminal (CLK) of the WDT IC 233. When operating normally, the CPU 232 periodically outputs a clear signal from the clear terminal to the WDT IC 233 in order to clear a counter of the WDT IC 233.

A reset terminal (RESET) of the CPU 232 is connected to a reset output terminal (RESET-O) of the WDT IC 233. When the reset signal is inputted from the WDT IC 233 to the reset terminal, the CPU 232 resets its state to the initial state by performing the restart.

An output terminal (OUT) of the CPU 232 is connected to an anode of the diode D11. As will be described later, based on the state of the switch 221-1 (headlight SW), the CPU 232 outputs a lighting command signal from the output terminal in order to light the headlight 213. The lighting command signal outputted from the CPU 232 is inputted to the high-side driver 235 through the diode D11 and the resistor R12.

For example, the lighting command signal is a signal of a positive logic (high active).

One end of the resistor R11 is connected to a cathode of the diode D11, and the other end is connected to the ground. One end of the resistor R12 is connected to the cathode of the diode D11, and the other end is connected to the high-side driver 235. One end of the resistor R13 is connected to the output terminal of the regulator 231, and the other end is connected to the reset terminal of the CPU 232.

The reset output terminal (RESET-O) of the WDT IC 233 is connected to the reset terminal of the CPU 232 and one end of a resistor R21 of the drive retaining and integrating circuit 234.

The WDT IC 233 includes the counter, and always performs counting during the operation. When the clear signal is inputted from the CPU 232 to the clock terminal, the WDT IC 233 resets the counter to restart the counting from the beginning.

On the other hand, when the clear signal is not inputted from the CPU 232 for a predetermined time but a value of the counter exceeds a predetermined threshold (that is, when the value is counted up), the WDT IC 233 starts to output the pulsing reset signal of a negative logic (low active) from the reset output terminal. The reset signal outputted from the WDT IC 233 is inputted to the reset terminal of the CPU 232 and the drive retaining and integrating circuit 234. When the clear signal is inputted from the CPU 232 during the output of the reset signal, the WDT IC 232 stops the output of the reset signal while resetting the counter.

The drive retaining and integrating circuit 234 includes resistors R21 to R31, capacitors C21 to C23, a diode D21, and transistors TR21 to TR24. The transistors TR21 and TR23 are an NPN type, and the transistors TR22 and TR24 are a PNP type.

One end of the resistor R21, which is different from the end connected to the reset output terminal of the WDT IC 233, is connected to the base of the transistor TR21. The resistor R22 is connected between the base and an emitter of the transistor TR21. The emitter of the transistor TR21 is connected to the power source VDD.

One end of the resistor R23 is connected to a collector of the transistor TR21, and the other end is connected to the base of the transistor TR22. The resistor R24 is connected between the base and the emitter of the transistor TR22. One end of the resistor R25 is connected to the emitter of the transistor TR21, and the other end is connected to the collector of the transistor TR22. The emitter of the transistor TR22 is connected to the ground.

One end of the resistor R26 is connected to the collector of the transistor TR22, and the other end is connected to one end of the capacitor C21. One end of the capacitor C21, which is different from the end connected to one end of resistor R26, is connected to the anode of the diode D21. The cathode of the diode D21 is connected to one end of the capacitor C22 and one end of the resistor R27. One end of the capacitor C22, which is different from the end connected to the cathode of the diode D21, is connected to the ground of the transistor TR22.

One end of the resistor R27, which is different from the end connected to the cathode of the diode D21, is connected to one end of the capacitor C23 and one end of the resistor R28. One end of the capacitor C23, which is different from the end connected to one end of resistor R27, is connected to the ground.

One end of the resistor R28, which is different from the end connected to one end of resistor R27, is connected to the base of the transistor TR23. The resistor R29 is connected between the base and the emitter of the transistor TR23. The emitter of the transistor TR23 is connected to the ground.

A circuit from the resistor R26 to the transistor TR23 constitutes an integrating circuit.

One end of the resistor R30 is connected to the collector of the transistor TR23, and the other end is connected to the base of the transistor TR24. The resistor R31 is connected between the base and the emitter of the transistor TR24. The collector of the transistor TR24 is connected to the cathode of the diode D11, and the emitter is connected to the ignition power source IG.

As will be described later, the transistor TR24 of the drive retaining and integrating circuit 234 is turned on when the predetermined number of pulses of the reset signal is inputted from the WDT IC 233. When both the transistor TR24 and the ignition power source IG are in the on state, the electric power is inputted from the ignition power source IG to the high-side driver 235 through the transistor TR24 and the resistor R12, and the input voltage at the high-side driver 235 is set to a high level.

Hereinafter, the signal of the positive logic (high active), which is outputted from the drive retaining and integrating circuit 234 to the high-side driver 235 using the electric power from the ignition power source IG, is referred to as an abnormal state lighting command signal.

Based on the lighting command signal inputted from the CPU 232 or the abnormal state lighting command signal inputted from the drive retaining and integrating circuit 234, the high-side driver 235 controls the lighting and turn-off of the headlight 213 by controlling the supply of the electric power from the battery power source +B to the headlight 213.

Hereinafter, a connection point among the reset terminal of the CPU 232, the reset output terminal of the WDT IC 233, and the resistor R21 is referred to as an A point. In FIG. 4, a connection point among the cathode of the diode D21, the capacitor C23, and the resistor R27 is referred to as a B point. In FIG. 4, an output point on the collector side of the transistor TR24 is referred to as a C point.

[Operation of In-Vehicle System 201 in Lighting Headlight 213]

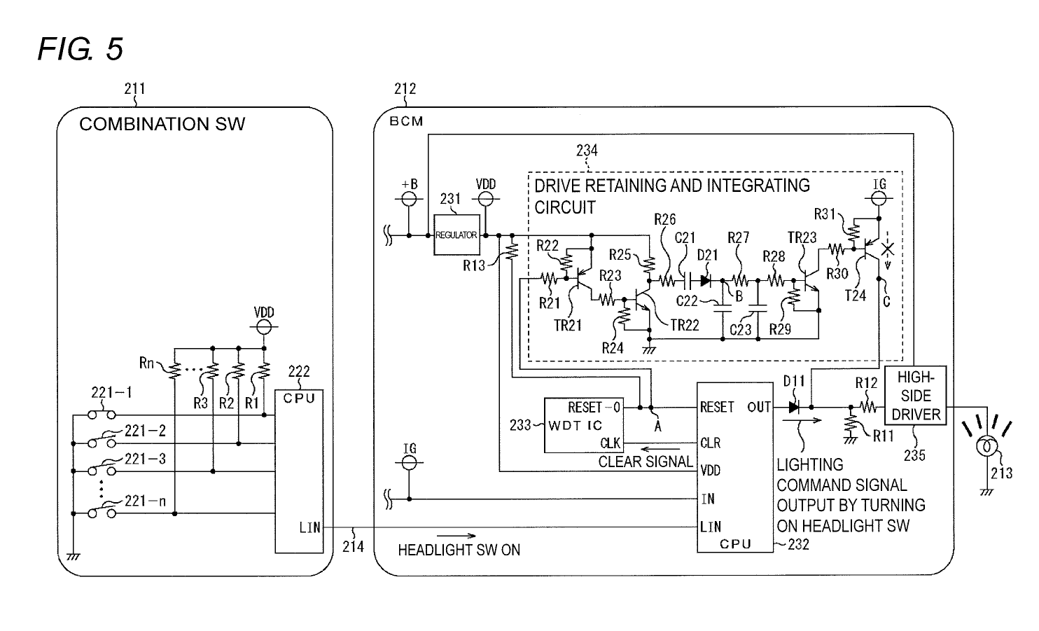

An operation of the in-vehicle system 201 in lighting the headlight 213 will be described with reference to FIGS. 5 to 8.

It is assumed that the transistors TR21 to TR24 of the drive retaining and integrating circuit 234 are turned off before the headlight 213 is lit.

(Normal Operation of In-Vehicle System 201)

A normal operation to light the headlight 213 in the case that the abnormality is not generated in the in-vehicle system 201 will be described with reference to FIG. 5.

When the headlight SW is turned on in order to light the headlight 213, the switch state signal indicating that the headlight SW is turned on is outputted from the line terminal of the CPU 222. The switch state signal outputted from the CPU 222 is inputted to the line terminal of the CPU 232 through the communication line 214.

When detecting the turn-on of the headlight SW based on the switch state signal, the CPU 232 outputs the lighting command signal from the output terminal (the lighting command signal is set to the high level) until the headlight SW is turned off. The lighting command signal outputted from the CPU 232 is inputted to the high-side driver 235 through the diode D11 and the resistor R12.

The high-side driver 235 supplies the electric power from the battery power source +B to the headlight 213 while the lighting command signal is inputted from the CPU 232. Therefore, the headlight 213 is lit.

During the normal operation, the CPU 232 periodically outputs the clear signal from the clear terminal to input the clear signal to the clock terminal of the WDT IC 233.

When the clear signal is inputted, the WDT IC 233 resets the counter. During the normal operation of the CPU 232, the counter of the WDT IC 233 does not count up the value, and the reset signal is not outputted from the WDT IC 233.

Accordingly, because the reset signal is not inputted to the drive retaining and integrating circuit 234, the state of the drive retaining and integrating circuit 234 does not change, but the transistor TR24 maintains the off state. Therefore, the drive retaining and integrating circuit 234 does not output the abnormal state lighting command signal.

(Operation of In-Vehicle System 201 in Communication Failure)

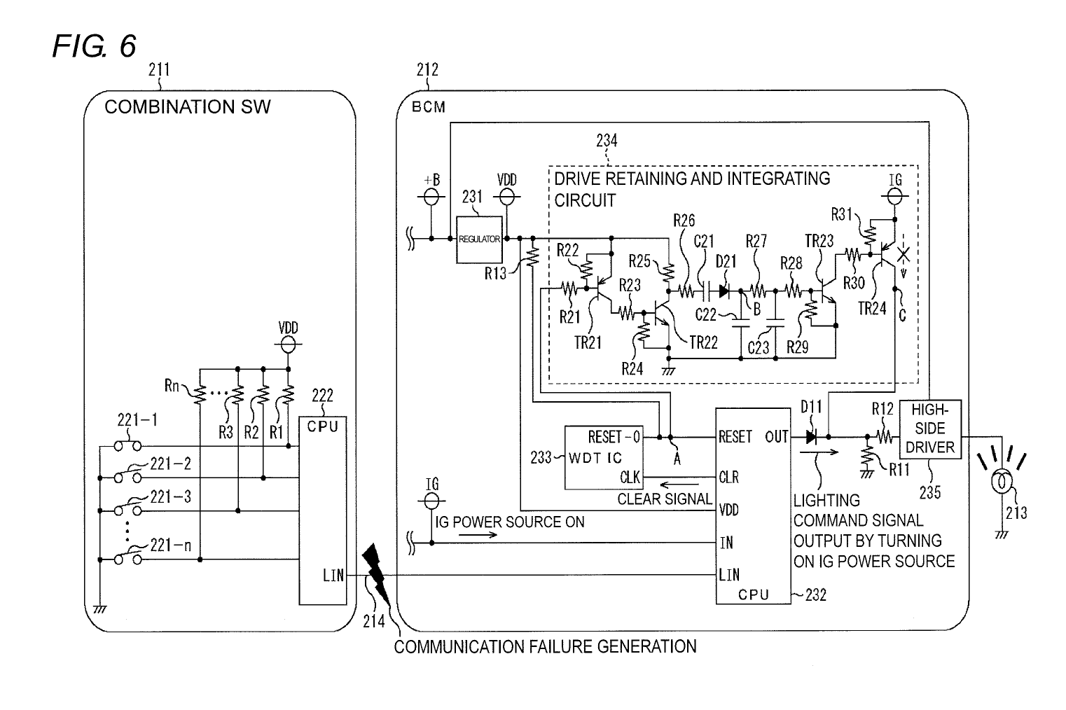

With reference to FIG. 6, a description will now be given of an operation to light the headlight 213 in the case that a communication failure is generated between the combination SW 211 and the BCM 212 in the in-vehicle system 201 due to a disconnection, a power-source short circuit, and a ground fault of the communication line 214 and the abnormality of the combination SW 211. It is assumed that the BCM 212 operates normally.

In this case, the CPU 232 cannot detect the state of the headlight SW because the CPU 232 cannot receive the switch state signal from the CPU 222 of the combination SW 211 due to the communication failure. On the other hand, the CPU 232 can detect the generation of the communication failure because all the signals inputted from the CPU 222 are stopped due to the communication failure.

Therefore, when detecting the communication failure, the CPU 232 controls the output of the lighting command signal based on the state of the ignition power source IG.

Specifically, the CPU 232 detects whether the ignition power source IG is turned on based on the input voltage at the input terminal. The CPU 232 outputs the lighting command signal from the output terminal (the lighting command signal is set to the high level) while the on state of the ignition power source IG is detected. Therefore, the headlight 213 is lit. On the other hand, the CPU 232 stops the output of the lighting command signal (the lighting command signal is set to the low level) while the off state of the ignition power source IG is detected. Therefore, the headlight 213 is turned off.

In the case that the communication failure is generated, the lighting and the turn-off of the headlight 213 is controlled in conjunction with the ignition power source IG. That is, even if the CPU 232 cannot detect the state of the headlight SW due to the communication failure, the ignition switch of the vehicle is set to the ignition to turn on the ignition power source IG, which allows the headlight 213 to be lit. Accordingly, the headlight 213 can be lit during the running of the vehicle to ensure the safe driving. On the other hand, the ignition switch of the vehicle is set to an accessory or the off state to turn off the ignition power source IG, which allows the headlight 213 to be turned off.

In this case, like the normal operation, the CPU 232 operates normally, the clear signal is periodically inputted from the CPU 232 to the WDT IC 233, but the reset signal is not outputted from the WDT IC 233. Therefore, the drive retaining and integrating circuit 234 does not output the abnormal state lighting command signal.

(Operation of In-Vehicle System 201 when Abnormality is Generated in CPU 232)

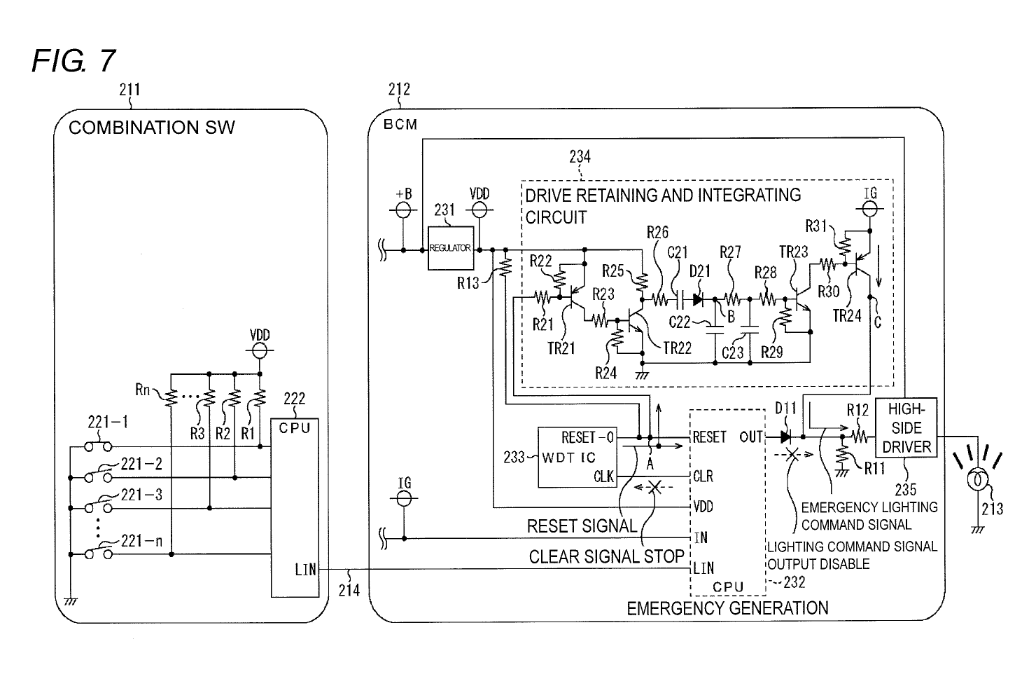

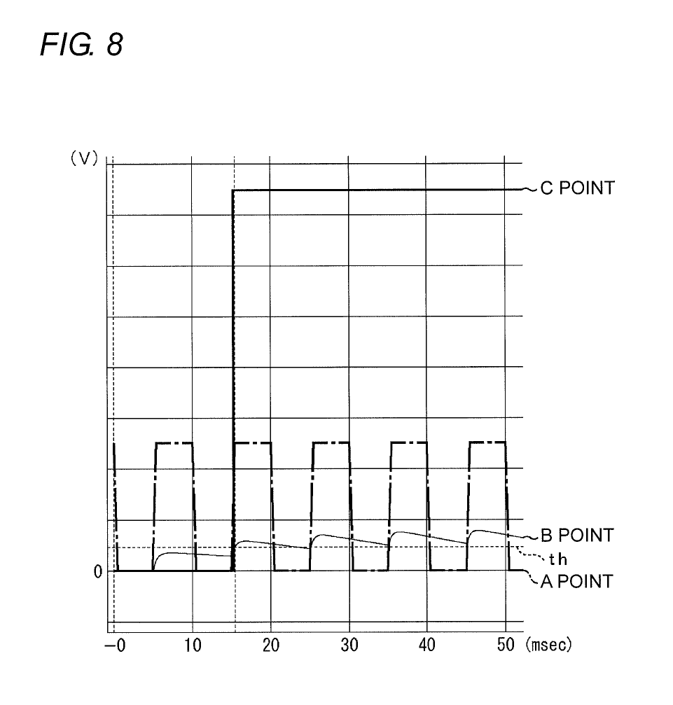

With reference to FIGS. 7 and 8, a description will now be given of an operation to light the headlight 213 in the case that the abnormality, such as a runaway and a sudden stop of the CPU 232 of the BCM 212, is generated in the in-vehicle system 201. In this case, the same operation is performed irrespective of the existence or non-existence of the generation of the communication failure between the combination SW 211 and the BCM 212.

Because the CPU 232 does not output the lighting command signal irrespective of the state of the headlight SW and the state of the ignition power source IG, the headlight 213 cannot be lit by the command from the CPU 232.

Due to the abnormality of the CPU 232, the CPU 232 does not output the clear signal to the WDT IC 233. As a result, the counter of the WDT IC 233 counts up the value, the WDT IC 233 starts the output of the reset signal from the reset output terminal.

FIG. 8 is a graph illustrating an example of changes in voltages from the A point to C point in FIG. 7 immediately after the WDT IC 233 starts the output of the reset signal. A waveform of the voltage at the A point is identical to a waveform of the reset signal.

The reset signal outputted from the WDT IC 233 is inputted to the drive retaining and integrating circuit 234, and inputted to the base of the transistor TR21 through the resistor R21. The transistor TR21 is turned on while the reset signal is set to the low level, and the transistor TR21 is turned off while the reset signal is set to the high level. When the transistor TR21 is turned on, a potential at the base of the transistor TR22 becomes the high level to turn on the transistor TR22. When the transistor TR21 is turned off, the potential at the base of the transistor TR22 becomes the low level to turn off the transistor TR22. Accordingly, the transistor TR22 repeats the turn-on and turn-off according to the pulse of the reset signal.

Based on the turn-on and the turn-off of the transistor TR22, the pulsing voltage is applied from the power source VDD to the capacitor C21 through the resistors R25 and R26. Therefore, the current is passed in the direction from the capacitor C21 toward the diode D21 to accumulate a charge in the capacitor C22. Every time the pulse of the reset signal is inputted to the drive retaining and integrating circuit 234, an accumulated charge amount of the capacitor C22 increases to raise the potential at the B point as illustrated in FIG. 8.

The predetermined number (for example, two) of reset signal pulses are inputted to the drive retaining and integrating circuit 234, and the accumulated charge amount of the capacitor C22 is greater than or equal to a predetermined threshold, and the potential at the B point is greater than or equal to a predetermined threshold th. At this point, the transistor TR23 is turned on. When the transistor TR23 is turned on, the potential at the base of the transistor TR24 becomes the low level to turn on the transistor TR24.

When the transistor TR24 becomes the on state, in the case that the ignition power source IG is in the on state, the electric power is inputted from the ignition power source IG to the high-side driver 235 through the transistor TR24 and the resistor R12 to raise the potential at the C point as illustrated in FIG. 8. That is, the abnormal state lighting command signal is inputted to the high-side driver 235 (the abnormal state lighting command signal is set to the high level).

The high-side driver 235 supplies the electric power from the battery power source +B to the headlight 213 while the abnormal state lighting command signal is inputted from the drive retaining and integrating circuit 234. Therefore, the headlight 213 is lit.

While the reset signal is inputted to the drive retaining and integrating circuit 234 after the potential at the B point becomes greater than or equal to the threshold th, the potential at the B point is maintained in the state greater than or equal to the threshold th, and therefore the transistor TR24 is maintained in the on state.

On the other hand, when the CPU 232 returns to the normal state to stop the output of the reset signal from the WDT IC 233, the potential at the B point becomes less than the threshold th to turn off the transistor TR24. As a result, the drive retaining and integrating circuit 234 stops the output of the abnormal state lighting command signal.

The headlight 213 can be lit by turning on the ignition power source IG until the CPU 232 returns to the normal state since the abnormality is generated in the CPU 232 to input the predetermined number of reset signal pulses to the drive retaining and integrating circuit 234. The headlight 213 can be turned off by turning off the ignition power source IG.

As described above, in the in-vehicle system 201, the headlight 213 can surely be lit even if the communication failure is generated between the combination SW211 and the BCM 212 or even if the abnormality is generated in the CPU 232.

A malfunction caused by a noise can be prevented because the abnormal state lighting command signal is outputted after the predetermined number of reset signal pulses are inputted.

### 2. Second Embodiment

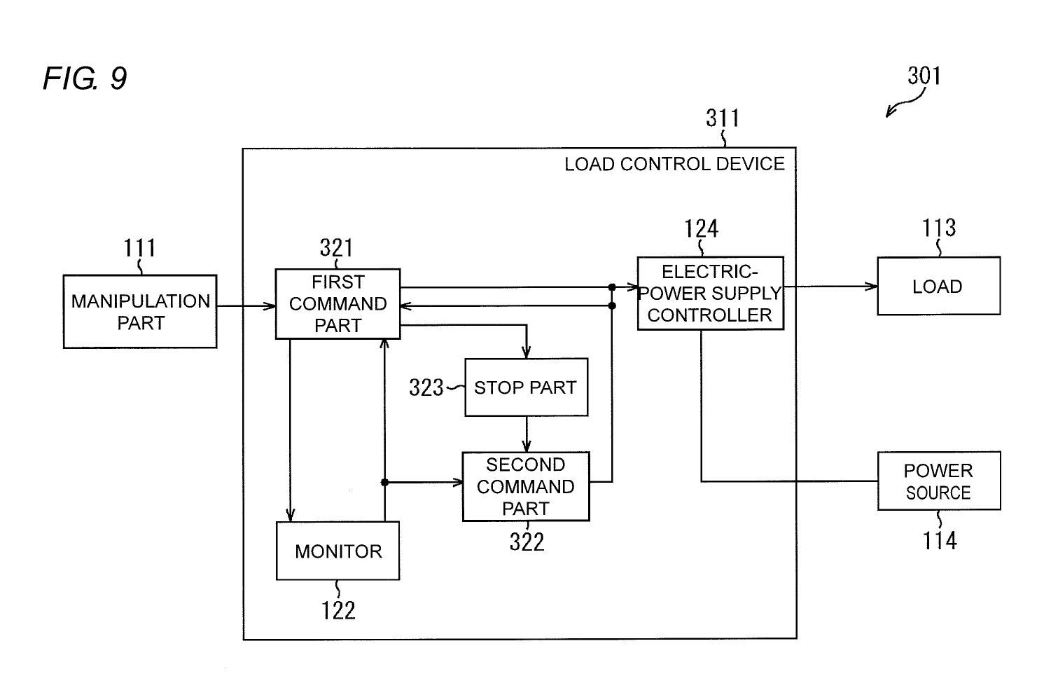

A second embodiment of the present invention will be described with reference to FIGS. 9 to 15.

[Basic Configuration Example of In-Vehicle System of Second Embodiment]

FIG. 9 is a block diagram illustrating a basic configuration example of an in-vehicle system according to the second embodiment of the present invention.

In FIG. 9, the component corresponding to that in FIG. 3 is designated by the same numeral, and the repetitive description of the same processing is omitted as appropriate.

An in-vehicle system 301 in FIG. 9 differs from the in-vehicle system 101 in FIG. 3 in that a load control device 311 is provided instead of the load control device 112. The load control device 311 differs from the load control device 112 in that a first command part 321 and a second command part 322 are provided instead of the first command part 121 and the second command part 123 and that a stop part 323 is added.

Like the in-vehicle system 101 in FIG. 3, the in-vehicle system 301 is a system, which is provided in various vehicles and controls the supply of the electric power to the load 113 according to the user manipulation of the manipulation part 111.

The first command part 321 has the same function as the first command part 121 in FIG. 3. Additionally, the first command part 321 has a function of controlling the stop part 323. Specifically, the first command part 321 can detect whether the second command part 322 issues the command to the electric-power supply controller 124 to supply the electric power to the load 113. During the normal operation of the first command part 321, while the second command part 322 issues the command to the electric-power supply controller 124 to supply the electric power to the load 113, the first command part 321 outputs a stop signal to the stop part 323 in order to stop the command. Particularly, the processing is performed when the first command part 321 is reset from the abnormal state to the normal state.

The second command part 322 has the same function as the second command part 123 in FIG. 3. Additionally, the second command part 322 has a function of stopping the command to the electric-power supply controller 124 to supply the electric power to the load 113 under the control of the stop part 323.

For example, the stop part 323 includes an electric circuit including a switching element, such as a transistor. In the case that the stop signal is inputted from the first command part 321, the stop part 323 causes the second command part 322 to stop the command to the electric-power supply controller 124 to supply the electric power to the load 113.

[Specific First Configuration Example of In-Vehicle System of Second Embodiment]

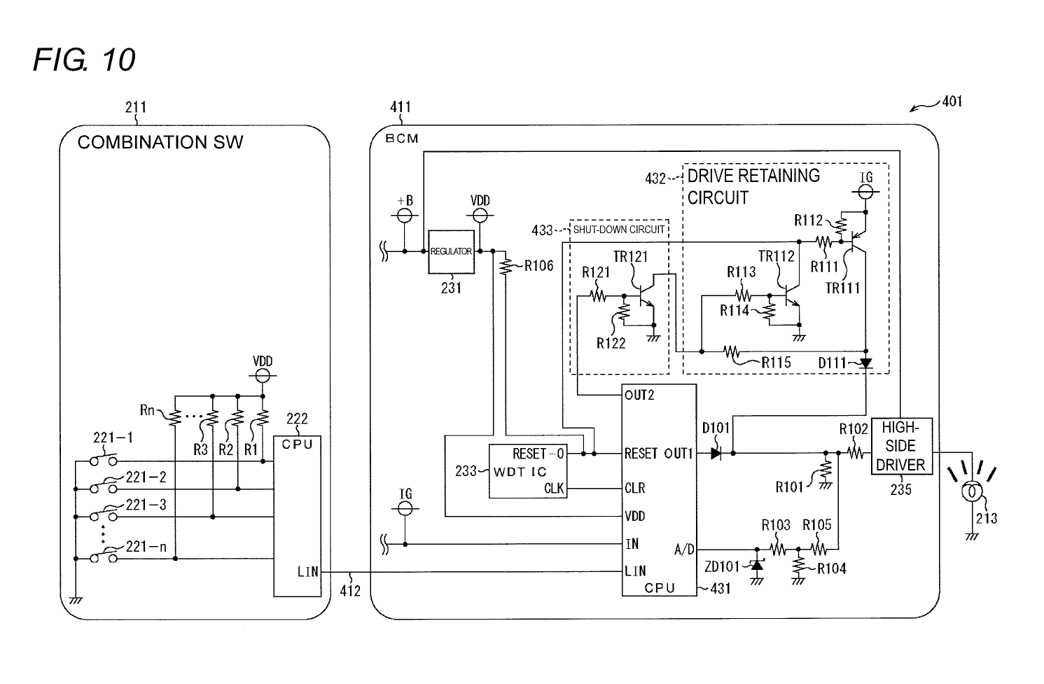

FIG. 10 is a circuit diagram illustrating a first configuration example of an in-vehicle system 401 in which the in-vehicle system 301 in FIG. 9 is objectified.

In FIG. 10, the component corresponding to that in FIG. 4 is designated by the same numeral, and the repetitive description of the same processing is omitted as appropriate.

The in-vehicle system 401 differs from the in-vehicle system 201 in FIG. 4 in that a BCM 411 is provided instead of the BCM 212.

The BCM 411 differs from the BCM 212 in that a CPU 431 is provided instead of the CPU 232 and that a drive retaining circuit 432 and a shut-down circuit 433 are provided instead of the drive retaining and integrating circuit 234. Additionally, the BCM 411 differs from the BCM 212 in that a diode D101, resistors R101 to R106, and a Zener diode ZD101 are provided while the diode D11 and the resistors R11 to R13 are not provided.

The CPU 431 corresponds to the first command part 321 in FIG. 9, the drive retaining circuit 432 corresponds to the second command part 322 in FIG. 9, and the shut-down circuit 433 corresponds to the stop part 323 in FIG. 9.

A line terminal (LIN) of the CPU 431 is connected to the line terminal (LIN) of the CPU 222 of the combination SW 211 through a communication line 412, and the CPU 222 and the CPU 431 communicate with each other through the communication line 412.

An input terminal (IN) of the CPU 431 is connected to the ignition power source IG. The CPU 431 detects the on and off states of the ignition power source IG based on the input voltage at the input terminal.

A power source terminal (VDD) of the CPU 431 is connected to the output terminal of the regulator 231 and the power source VDD.

A clear terminal (CLR) of the CPU 431 is connected to the clock terminal (CLK) of the WDT IC 233. When operating normally, the CPU 431 periodically outputs the clear signal from the clear terminal to the WDT IC 233 in order to clear the counter of the WDT IC 233.

A reset terminal (RESET) of the CPU 431 is connected to the reset output terminal (RESET-O) of the WDT IC 233. When the reset signal is inputted from the WDT IC 233 to the reset terminal, the CPU 431 resets its state to the initial state by performing the restart.

An output terminal 1 (OUT1) of the CPU 431 is connected to an anode of the diode D101. Like the CPU 232 in FIG. 4, based on the state of the switch 221-1 (headlight SW), the CPU 431 outputs the lighting command signal from the output terminal 1 in order to light the headlight 213. The lighting command signal outputted from the CPU 431 is inputted to the high-side driver 235 through the diode D101 and the resistor R102.

An output terminal 2 (OUT2) of the CPU 431 is connected to one end of the resistor R121 of the shut-down circuit 433. As will be described later, the CPU 431 outputs the stop signal of the positive logic (high active) from the output terminal 2 in order to stop the abnormal state lighting command signal outputted from the drive retaining circuit 432, and inputs the stop signal to the shut-down circuit 433.

An analog terminal (ND) of the CPU 431 is connected to a cathode of the Zener diode ZD101 and one end of the resistor R103. Based on the input voltage at the analog terminal, the CPU 431 detects whether the drive retaining circuit 432 outputs the abnormal state lighting command signal.

One end of the resistor R101 is connected to the cathode of the diode D101, and the other end is connected to the ground. One end of the resistor R102 is connected to the cathode of the diode D101, and the other end is connected to the high-side driver 235. The anode of the Zener diode ZD101 is connected to the ground. One end of the resistor R103, which is different from the end connected to the analog terminal of the CPU 431, is connected to one end of the resistor R104 and one end of the resistor R105. One end of the resistor R104, which is different from the end connected to one end of resistor R103, is connected to the ground. One end of the resistor R105, which is different from the end connected to one end of resistor R103, is connected to the cathode of the diode D101. One end of the resistor R106 is connected to the output terminal of the regulator 231, and the other end is connected to the reset terminal of the CPU 431.

The drive retaining circuit 432 includes resistors R111 to R115, a diode D111, and transistors TR111 and TR112. The transistor TR111 is the PNP type, and the transistor TR112 is the NPN type.

One end of the resistor R111 is connected to the reset output terminal of the WDT IC 233, and the other end is connected to the base of the transistor TR111. The resistor R112 is connected between the base and the emitter of the transistor TR111. The collector of the transistor TR111 is connected to the anode of the diode D111, and the emitter is connected to the ignition power source IG. The cathode of the diode D111 is connected to the cathode of the diode D101.

One end of the resistor R113 is connected to one end of the resistor R115, and the other end is connected to the base of the transistor TR112. The resistor R114 is connected between the base and the emitter of the transistor TR112. The collector of the transistor TR112 is connected to the reset output terminal of the WDT IC 233, and the emitter is connected to the ground. One end of the resistor R115, which is different from the end connected to one end of resistor R113, is connected to the collector of the transistor TR111.

As will be described later, the transistor TR111 of the drive retaining circuit 432 is turned on when the reset signal is inputted from the WDT IC 233, and the transistor TR111 is maintained in the on state until turned off by the shut-down circuit 433. When both the transistor TR111 and the ignition power source IG are in the on state, the electric power is inputted from the ignition power source IG to the high-side driver 235 through the transistor TR111, the diode D111, and the resistor R102, and the input voltage at the high-side driver 235 is set to the high level.

Hereinafter, the signal of the positive logic (high active), which is outputted from the drive retaining circuit 432 to the high-side driver 235 using the electric power from the ignition power source IG, is referred to as an abnormal state lighting command signal.

The shut-down circuit 433 includes resistors R121 and R122 and an NPN-type transistor TR121.

One end of the resistor R121, which is different from the end connected to the output terminal 2 of the CPU 431, is connected to the base of the transistor TR121. The resistor R122 is connected between the base and the emitter of the transistor TR121. The collector of the transistor TR121 is connected to one end of the drive retaining circuit 432, which is different from the end connected to the base of the transistor TR112 of the resistor R113, and the emitter is connected to the ground.

As will be described later, the transistor TR121 of the shut-down circuit 433 is turned on when the stop signal is inputted from the CPU 431, and the transistor TR111 of the drive retaining circuit 432 is turned off when the transistor TR121 is turned on. Therefore, the abnormal state lighting command signal outputted from the drive retaining circuit 432 is stopped.

[Operation of In-Vehicle System 401 in Lighting Headlight 213]

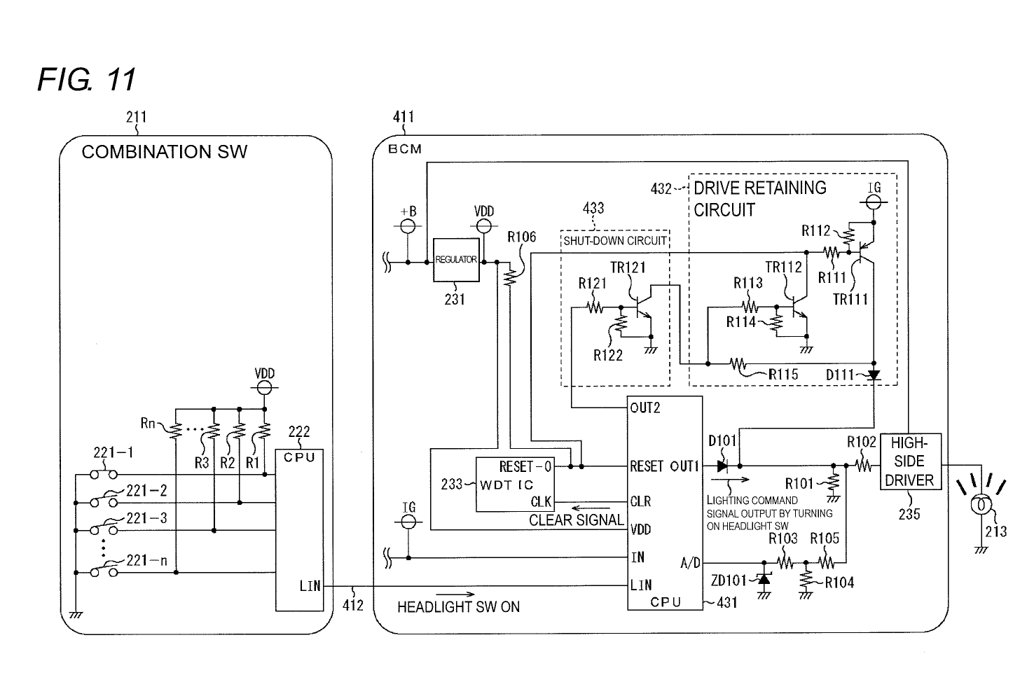

An operation of the in-vehicle system 401 in lighting the headlight 213 will be described with reference to FIGS. 11 to 13.

It is assumed that the transistors TR111 and TR112 of the drive retaining circuit 432 and the transistor TR121 of the shut-down circuit 433 are turned off before the headlight 213 is lit.

(Normal Operation of In-Vehicle System 401)

A normal operation to light the headlight 213 in the case that the abnormality is not generated in the in-vehicle system 401 will be described with reference to FIG. 11.

When the headlight SW is turned on in order to light the headlight 213, the switch state signal indicating that the headlight SW is turned on is outputted from the line terminal of the CPU 222. The switch state signal outputted from the CPU 222 is inputted to the line terminal of the CPU 431 through the communication line 412.

When detecting the turn-on of the headlight SW based on the switch state signal, the CPU 431 outputs the lighting command signal from the output terminal 1 (the lighting command signal is set to the high level) until the headlight SW is turned off. The lighting command signal outputted from the CPU 431 is inputted to the high-side driver 235 through the diode D101 and the resistor R102.

The high-side driver 235 supplies the electric power from the battery power source +B to the headlight 213 while the lighting command signal is inputted from the CPU 431. Therefore, the headlight 213 is lit.

During the normal operation, the CPU 431 periodically outputs the clear signal from the clear terminal to input the clear signal to the clock terminal of the WDT IC 233.

When the clear signal is inputted, the WDT IC 233 resets the counter. During the normal operation of the CPU 431, therefore, the counter of the WDT IC 233 does not count up the value, and the reset signal is not outputted from the WDT IC 233.

Accordingly, because the reset signal is not inputted to the drive retaining circuit 432, the state of the drive retaining circuit 432 does not change, but the transistor TR111 is maintained in the off state. Therefore, the drive retaining circuit 432 does not output the abnormal state lighting command signal.

(Operation of In-Vehicle System 401 in Communication Failure)

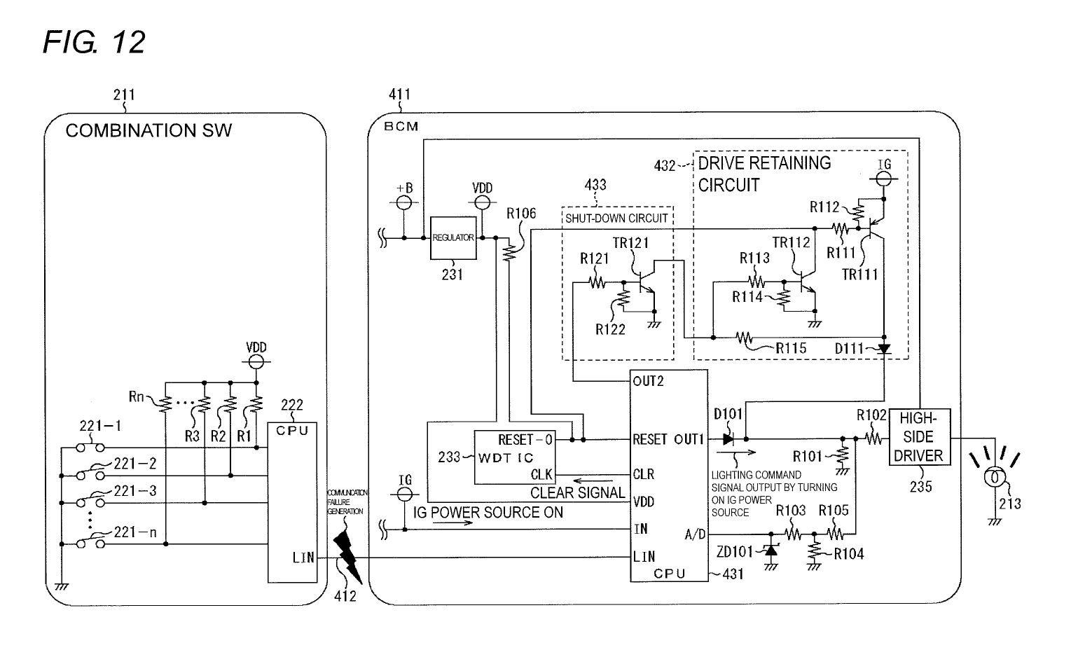

With reference to FIG. 12, a description will now be given of an operation to light the headlight 213 in the case that the communication failure is generated between the combination SW 211 and the BCM 411 in the in-vehicle system 401 due to the disconnection, the power-source short circuit, and the ground fault of the communication line 412 and the abnormality of the combination SW 211. It is assumed that the BCM 411 operates normally.

In this case, the CPU 431 cannot detect the state of the headlight SW because the CPU 431 cannot receive the switch state signal from the CPU 222 of the combination SW 211 due to the communication failure. On the other hand, the CPU 431 can detect the generation of the communication failure because all the signals inputted from the CPU 222 are stopped due to the communication failure.

Therefore, when detecting the communication failure, the CPU 431 controls the output of the lighting command signal based on the state of the ignition power source IG.

Specifically, the CPU 431 detects whether the ignition power source IG is turned on based on the input voltage at the input terminal. The CPU 431 outputs the lighting command signal from the output terminal 1 (the lighting command signal is set to the high level) while the on state of the ignition power source IG is detected. Therefore, the headlight 213 is lit. On the other hand, the CPU 431 stops the output of the lighting command signal (the lighting command signal is set to the low level) while the off state of the ignition power source IG is detected. Therefore, the headlight 213 is turned off.

In the case that the communication failure is generated, the lighting and the turn-off of the headlight 213 is controlled in conjunction with the ignition power source IG. That is, even if the CPU 431 cannot detect the state of the headlight SW due to the communication failure, the ignition switch of the vehicle is set to the ignition to turn on the ignition power source IG, which allows the headlight 213 to be lit. Accordingly, the headlight 213 can be lit during the running of the vehicle to ensure the safe driving. On the other hand, the ignition switch of the vehicle is set to an accessory or the off state to turn off the ignition power source IG, which allows the headlight 213 to be turned off.

In this case, like the normal operation, the CPU 431 operates normally, the clear signal is periodically inputted from the CPU 431 to the WDT IC 233, but the reset signal is not outputted from the WDT IC 233. Therefore, the drive retaining circuit 432 does not output the abnormal state lighting command signal.

(Operation of In-Vehicle System 401 when Abnormality is Generated in CPU 431)

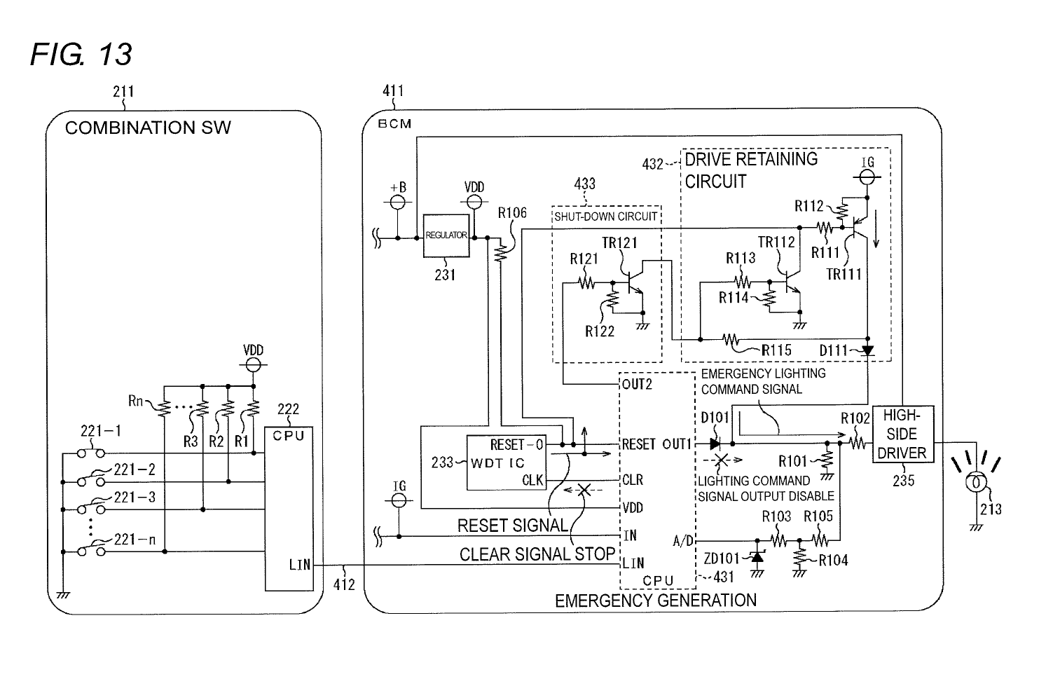

With reference to FIG. 13, a description will now be given of an operation to light the headlight 213 in the case that the abnormality, such as the runaway of the CPU 431 of the BCM 411, is generated in the in-vehicle system 401. In this case, the same operation is performed irrespective of the existence or non-existence of the generation of the communication failure between the combination SW 211 and the BCM 411.

Because the CPU 431 does not output the lighting command signal irrespective of the state of the headlight SW and the state of the ignition power source IG, the headlight 213 cannot be lit by the command from the CPU 431.

Due to the abnormality of the CPU 431, the CPU 431 does not output the clear signal to the WDT IC 233. As a result, the counter of the WDT IC 233 counts up the value, the WDT IC 233 starts the output of the reset signal from the reset output terminal.

The reset signal outputted from the WDT IC 233 is inputted to the drive retaining circuit 432, and inputted to the base of the transistor TR111 through the resistor R111. As described above, because the reset signal is the pulse signal of the negative logic, the transistor TR111 is turned on at the time the first pulse of the reset signal is inputted to the base.

When the transistor TR111 is turned on, the ignition power source IG is connected to the base of the transistor TR112 through the transistor TR111 and the resistors R115 and R113. Accordingly, the transistor TR112 is turned on when the ignition power source IG is turned on.

When the transistor TR112 is turned on, the base of the transistor TR111 is connected to the ground through the resistor R111 and the transistor TR112. Accordingly, while the transistor TR112 is turned on, the transistor TR111 is maintained in the on state irrespective of the existence or non-existence of the input of the reset signal. The transistor TR112 is also maintained in the on state by maintaining the transistor TR111 in the on state.

Accordingly, while the ignition power source IG is turned on after the transistors TR111 and TR112 are turned on, even if the reset signal inputted to the drive retaining circuit 432 is stopped, as will be described, the on states of the transistors TR111 and TR112 are maintained until the shut-down circuit 433 turns off the transistors TR111 and TR112.

While the transistor TR111 and the ignition power source IG are turned on, the electric power is inputted from the ignition power source IG to the high-side driver 235 through the transistor TR111, the diode D111, and the resistor R102, and the abnormal state lighting command signal is inputted to the high-side driver 235 (the abnormal state lighting command signal is set to the high level).

The high-side driver 235 supplies the electric power from the battery power source +B to the headlight 213 while the abnormal state lighting command signal is inputted from the drive retaining circuit 432. Therefore, the headlight 213 is lit.

On the other hand, when the ignition power source IG is turned off while the reset signal is inputted to the drive retaining circuit 432, the drive retaining circuit 432 stops, but the abnormal state lighting command signal is not outputted, thereby turning off the headlight 213.

Then, in the case that the CPU 431 returns to the normal state, the CPU 431 resumes the output of the clear signal from the clear terminal. Therefore, the counter of the WDT IC 233 is reset, and the WDT IC 233 stops the output of the reset signal.

Based on the input voltage at the analog terminal, the CPU 431 detects whether the drive retaining circuit 432 outputs the abnormal state lighting command signal. When detecting the output of the abnormal state lighting command signal, until the abnormal state lighting command signal is stopped, the CPU 431 outputs the stop signal from the output terminal 2 and inputs the stop signal to the shut-down circuit 433.

The stop signal inputted to the shut-down circuit 433 is inputted to the base of the transistor TR121 through the resistor R121, thereby turning on the transistor TR121. When the transistor TR121 is turned on, the collector current of the transistor TR111 is passed through a route of the resistor R115, the transistor TR121, and the ground, but the collector current does not flow in the base of the transistor TR112. Therefore, the transistor TR112 is turned off. When the transistor TR112 is turned off, the transistor TR111 is also turned off because the reset signal is not inputted. As a result, the abnormal state lighting command signal outputted from the drive retaining circuit 432 is stopped.

Accordingly, until the CPU 431 returns to the normal state since the abnormality is generated in the CPU 431, the headlight 213 can be lit by turning on the ignition power source IG. The headlight 213 can be turned off by turning off the ignition power source IG.

As described above, in the in-vehicle system 401, the headlight 213 can surely be lit even if the communication failure is generated between the combination SW211 and the BCM 411 or even if the abnormality is generated in the CPU 431.

[Specific Second Configuration Example of In-Vehicle System of Second Embodiment]

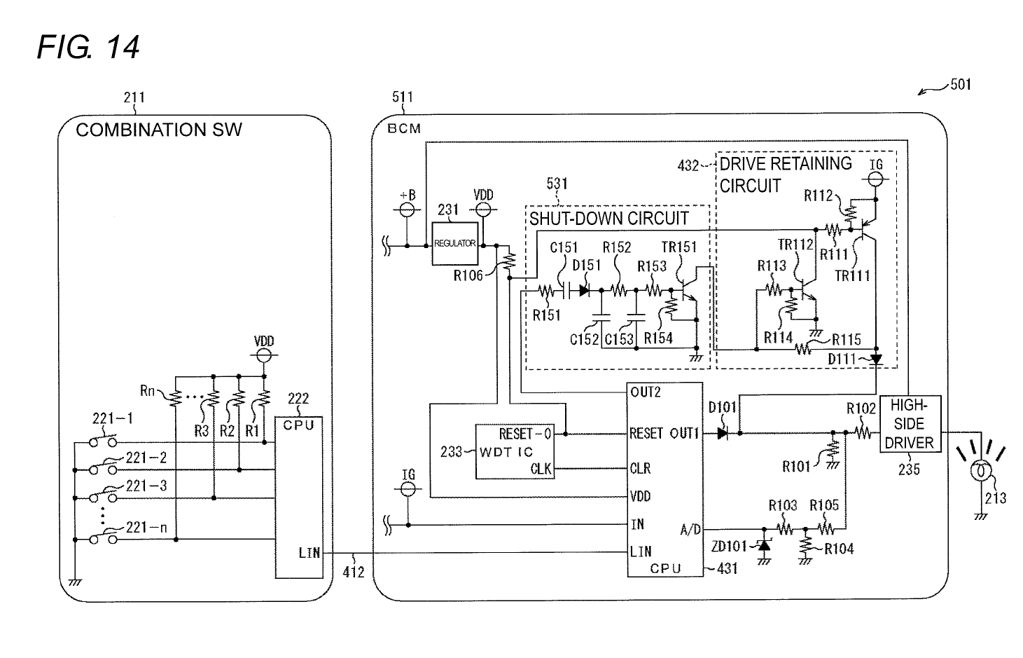

FIG. 14 is a block diagram illustrating a second configuration example of an in-vehicle system 501 in which the in-vehicle system 301 in FIG. 9 is objectified.

In FIG. 14, the component corresponding to that in FIG. 10 is designated by the same numeral, and the repetitive description of the same processing is omitted as appropriate.

The in-vehicle system 501 differs from the in-vehicle system 401 in that a BCM 511 is provided instead of the BCM 411. The BCM 511 differs from the BCM 411 in that a shut-down circuit 531 is provided instead of the shut-down circuit 433.

The shut-down circuit 531 includes resistors R151 to R154, capacitors C151 to C153, diode D151, and a transistor TR151.

One end of the resistor R151 is connected to the output terminal 2 of the CPU 431, and the other end is connected to one end of the capacitor C151. One end of the capacitor C151, which is different from the end connected to one end of resistor R151, is connected to the anode of the diode D151. The cathode of the diode D151 is connected to one end of the resistor R152 and one end of the capacitor C152. One end of the capacitor C152, which is different from the end connected to the cathode of the diode D151, is connected to the ground.

One end of the resistor R152, which is different from the end connected to the cathode of the diode D151, is connected to one end of the resistor R153 and one end of the capacitor C153. One end of the capacitor C153, which is different from the end connected to one end of resistor R152, is connected to the ground.

One end of the resistor R153, which is different from the end connected to one end of resistor R152, is connected to the base of the transistor TR151. The resistor R154 is connected between the base and the emitter of the transistor TR151. The collector of the transistor TR151 is connected to one end of the drive retaining circuit 432, which is different from the end connected to the base of the transistor TR112 of the resistor R113, and the source is connected to the ground.

The CPU 431 outputs the pulsing stop signal of the positive logic (high active) from the output terminal 2, and inputs the stop signal to the shut-down circuit 531.

[Operation of In-Vehicle System 501 in Lighting Headlight 213]

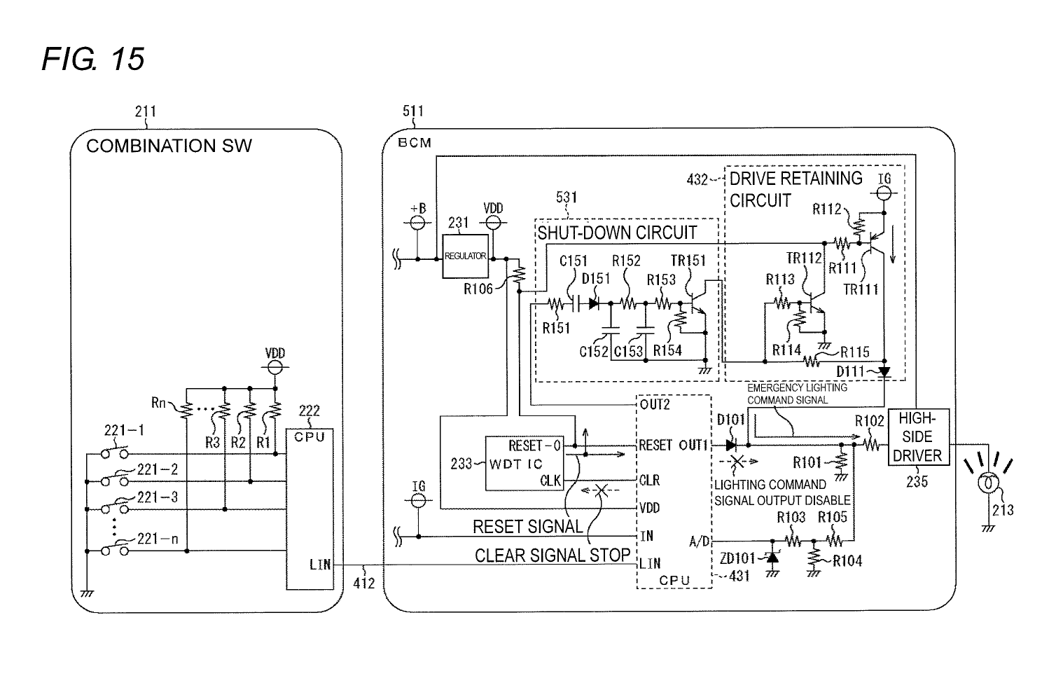

An operation of the in-vehicle system 501 in lighting the headlight 213 will be described with reference to FIG. 15.

The normal operation of the in-vehicle system 501 and the operation of the in-vehicle system 501 during the generation of the communication failure are identical to those of the in-vehicle system 401, the repetitive description is omitted.

(Operation of In-Vehicle System 501 when Abnormality is Generated in CPU 431)

With reference to FIG. 15, a description will now be given of an operation to light the headlight 213 in the case that the abnormality, such as the runaway of the CPU 431 of the BCM 511, is generated in the in-vehicle system 501. In this case, the same operation is performed irrespective of the existence or non-existence of the generation of the communication failure between the combination SW 211 and the BCM 511.

During the generation of the abnormality in the CPU 431, the operation of the in-vehicle system 501 differs from the operation of the in-vehicle system 401 only in the operation in the case that the abnormal state lighting command signal outputted from the drive retaining circuit 432 is stopped.

Specifically, the shut-down circuit 531 has the same configuration as the integrating circuit between the resistor R26 and the transistor TR23 of the drive retaining and integrating circuit 234 in FIG. 4. Accordingly, the transistor TR151 of the shut-down circuit 531 is turned on when the predetermined number of stop signal pulses are inputted from the CPU 431 to the shut-down circuit 531.

In the BCM 411 in FIG. 10, the abnormal state lighting command signal outputted from the drive retaining circuit 432 is stopped when the initial stop signal pulse is inputted to the shut-down circuit 433. On the other hand, in the BCM 511, the abnormal state lighting command signal outputted from the drive retaining circuit 432 is stopped when the predetermined number of stop signal pulses are inputted to the shut-down circuit 531. Therefore, the malfunction caused by the noise can be prevented.

### 3. Modifications

Modifications of the embodiments of the present invention will be described below.

For example, in the in-vehicle system 101 in FIG. 3, the reset signal may be outputted only to the second command part 123 when the monitor 122 detects the abnormality of the first command part 121. When the reset signal is inputted from the monitor 122, the second command part 123 may issue the command to the electric-power supply controller 124 to supply the electric power to the load 113 based on the power source state of the vehicle.

For example, in the in-vehicle system 301 in FIG. 9, the reset signal may be outputted only to the second command part 322 when the monitor 122 detects the abnormality of the first command part 321. When the reset signal is inputted from the monitor 122, the second command part 322 may issue the command to the electric-power supply controller 124 to supply the electric power to the load 113 based on the power source state of the vehicle.

In this case, because the reset signal is not used to reset the state of the first command part 121 or the first command part 321, the reset signal act only as a fault detection signal providing a notification of the abnormality of the first command part 121.

The circuit configuration of the BCM is described above by way of example, and can appropriately be changed.

For example, an FET (Field Effect Transistor) may be used instead of the bipolar transistor.

With the change of the circuit configuration, a positive logic and a negative logic of each signal may be reversed, the pulse signal may be changed to a continuous signal, or the continuous signal may be changed to the pulse signal.

In FIGS. 10 to 15, the drive retaining circuit 432 and the shut-down circuit 433 or the shut-down circuit 531 include circuit elements, such as the transistor, by way of example. For example, an IC circuit having the same functions as the circuit elements may be used.

In the above description, by way of example, the CPU 431 outputs the stop signal when the abnormal state lighting command signal outputted from the drive retaining circuit 432 is detected. For example, the stop signal may be outputted irrespective of the existence or non-existence of the output of the abnormal state lighting command signal.

In the above description, by way of example, the CPU 222 is provided between the switches 221-1 to 221-n and the BCM, and the CPU 222 communicates with the BCM. However, one or more embodiments of the present invention can also be applied to the case that the switch and the BCM communicate with each other while the switch is directly connected to the BCM through the communication line.

One or more embodiments of the present invention can also be applied to the case that the supply of the electric power to the in-vehicle electric component except the headlight is controlled.

In the above description, by way of example, the headlight 213 is lit in conjunction with the ignition power source IG when the communication failure or the abnormality of the CPU is generated. For example, the headlight 213 may be lit in conjunction with another power source (for example, an accessory power source) according to the kind of the load.

The present invention is not limited to the above embodiments, but various changes can be made without departing from the scope of the present invention.

1. A load control device that controls a load of a vehicle based on a signal inputted from a manipulation part manipulated by a user, the load control device comprising:
a first command part that issues a first command to supply electric power to the load based on the signal from the manipulation part;
a monitor that monitors existence or non-existence of an abnormality of the first command part, and outputs a reset signal in order to reset a state of the first command part when the abnormality of the first command part is detected;
a second command part that issues a second command to supply the electric power to the load when the reset signal is inputted from the monitor; and
an electric-power supply controller that controls the supply of the electric power to the load based on the first command or the second command.

2. The load control device according to claim 1, wherein the second command part issues the second command when a predetermined power source of the vehicle is turned on.

3. The load control device according to claim 2, wherein the second command part issues the second command by outputting the electric power from the predetermined power source of the vehicle to the electric-power supply controller.

4. The load control device according to claim 1, wherein the first command part issues the first command based on a state of the predetermined power source of the vehicle when communication failure is detected between the first command part and the manipulation part.

5. The load control device according to claim 2, wherein the predetermined power source of the vehicle is a power source of a drive system of the vehicle.

6. The load control device according to claim 1, wherein the reset signal is a pulsing signal, and
the second command part issues the second command when a predetermined number of pulses of the reset signal are inputted.

7. The load control device according to claim 6, wherein the second command part includes an integrating circuit including a capacitor, and the second command part issues the second command when a charge amount accumulated in the capacitor by the input of the reset signal is greater than or equal to a predetermined threshold.

8. The load control device according to claim 1, wherein the first command part outputs a stop signal in order to stop the second command when operating normally, and
the load control device further comprises a stop part that stops the second command issued by the second command part when the stop signal is inputted from the first command part.

9. The load control device according to claim 8, wherein the first command part detects whether the second command part issues the second command, and the first command part outputs the stop signal when the second command part issues the second command while the first command part operates normally.

10. The load control device according to claim 8, wherein the stop signal is a pulsing signal, and
the stop part stops the second command issued by the second command part when a predetermined number of pulses of the stop signal are inputted.

11. The load control device according to claim 10, wherein the stop part includes an integrating circuit including a capacitor, and the stop part stops the second command issued by the second command part when a charge amount accumulated in the capacitor by the input of the stop signal is greater than or equal to a predetermined threshold.

12. A load control device that controls a load of a vehicle based on a signal inputted from a manipulation part manipulated by a user, the load control device comprising:
a first command part that issues a first command to supply electric power to the load based on the signal from the manipulation part;
a monitor that monitors existence or non-existence of an abnormality of the first COMMAND part, and outputs a fault detection signal when the abnormality of the first command part is detected;
a second command part that issues a second command to supply the electric power to the load when the fault detection signal is inputted from the monitor; and
an electric-power supply controller that controls the supply of the electric power to the load based on the first command or the second command.

13. The load control device according to claim 2, wherein the first command part issues the first command based on a state of the predetermined power source of the vehicle when communication failure is detected between the first command part and the manipulation part.

14. The load control device according to claim 3, wherein the first command part issues the first command based on a state of the predetermined power source of the vehicle when communication failure is detected between the first command part and the manipulation part.

15. The load control device according to claim 3, wherein the predetermined power source of the vehicle is a power source of a drive system of the vehicle.

16. The load control device according to claim 4, wherein the predetermined power source of the vehicle is a power source of a drive system of the vehicle.

17. The load control device according to claim 2, wherein the reset signal is a pulsing signal, and
the second command part issues the second command when a predetermined number of pulses of the reset signal are inputted.

18. The load control device according to claim 3, wherein the reset signal is a pulsing signal, and
the second command part issues the second command when a predetermined number of pulses of the reset signal are inputted.

19. The load control device according to claim 4, wherein the reset signal is a pulsing signal, and
the second command part issues the second command when a predetermined number of pulses of the reset signal are inputted.

20. The load control device according to claim 5, wherein the reset signal is a pulsing signal, and
the second command part issues the second command when a predetermined number of pulses of the reset signal are inputted.
